(19) United States
(12) Patent Application Publication
(10) Pub. No.: US 2017/0351326 A1
(43) Pub. Date: Dec. 7, 2017

(54) EYE TRAINING SYSTEM AND COMPUTER PROGRAM PRODUCT

(71) Applicant: KONINKLIJKE PHILIPS N.V., EINDHOVEN (NL)

(72) Inventors: RONALDUS MARIA AARTS, GELDROP (NL); RADU SERBAN JASINSCHI, NUENEN (NL); CAIFENG SHAN, VELDHOVEN (NL)

(21) Appl. No.: 15/526,559

(22) PCT Filed: Nov. 4, 2015
(86) PCT No.: PCT/EP2015/075652

§ 371 Date: May 12, 2017

(30) Foreign Application Priority Data
Nov. 18, 2014 (EP) 14193605.4

(51) Int. Cl. G06F 3/01; A61H 5/00

(52) U.S. Cl. CPC G06F 3/013; A61H 5/005; A61H 2201/1607; A61H 2201/5007; A61H 2201/165

(57) ABSTRACT

Disclosed is an eye training system (10) including a head-mountable computing device (100) comprising at least one display module (106, 106′) arranged to be viewed by the wearer of the head-mountable computing device when wearing the device; and a display processor (108) coupled to the at least one display module for controlling the at least one display module and adapted to display an initial set of eye exercises on the at least one display module; a sensor arrangement (120) for monitoring eye responses of the wearer to the displayed initial set of eye exercises; and a data processor (110) adapted to receive eye response data from the sensor arrangement and to process the eye response data; wherein the display processor is further adapted to display a subsequent set of eye exercises on the at least one display module in response to a processing result of the processed eye response data. A computer program product is also disclosed.

### FIELD OF THE INVENTION

The present invention relates to an eye training system including a head-mountable computing device.

The present invention further relates to a computer program product including eye training instructions for execution on such an eye training system.

### BACKGROUND OF THE INVENTION

Vision therapy, also known as vision training, is used to improve vision skills such eye movement control, eye coordination and teamwork. It typically involves a series of procedures carried out in both home and office settings, usually under professional supervision by an orthoptist or optometrist.

Vision therapy may be prescribed when a comprehensive eye examination indicates that it is an appropriate treatment option for the patient. The specific program of therapy is based on the results of standardized tests, the needs of the patient, and the patient's signs and symptoms. Programs typically involve eye exercises and the use of lenses, prisms, filters, occluders, specialized instruments, and/or computer programs. For instance, orthoptics aims to treat binocular vision disorders such as strabismus, and diplopia. Key factors involved in exercises for treating such disorders for example include eye movement control, simultaneous focus at far, sustaining focus at far, simultaneous focus at near, sustaining focus at near, simultaneous alignment at far, sustaining alignment at far, simultaneous alignment at near, sustaining alignment at near, central vision (visual acuity) and depth awareness.

The course of therapy may last weeks to several years, with intermittent monitoring by the eye doctor. The length of such therapy may be considered frustrating by the patient and can lead to non-compliance with the exercise regime, thereby reducing or even cancelling the effectiveness of the therapy. A further problem is that the initial set of exercises prescribed by the eye doctor may prove to be non-optimal for the treatment of a particular patient, for instance because the exercises prove to be too easy or too difficult, which may negatively impact on the effectiveness of the treatment. Due to the intermittent nature of the consultations between the eye doctor and the patient, such non-optimal training regimes may remain undetected for prolonged periods of time, which negatively affects the effectiveness and consequentially the duration of the treatment. Moreover, as the eye doctor has not witnessed the level of compliance with the prescribed exercises, the full scale of the non-compliance may not even be detected.

The advent of smart headgear, i.e. head-mountable computing devices, has opened a new gateway to the implementation of such eye training exercises by displaying them on the head-mountable computing device. For example, WO 2012/022042 A1 discloses a head-worn vision enhancing system on a spectacle-type support, on which are mounted: left and a right micro-display chips, left and a right wide-visual-angle optical prisms for reflecting image rays emitted from the left and right micro-display chips with curved surfaces to human eyes, and a control circuit for transmitting a video signal to the left and right micro-display chips. The control circuit is a control circuit for stereoscopic images, which is used to process a stereoscopic video signal, divide it into a left and a right video signals, and then transmit them to the left and right micro-display chips, so as to display stereoscopic images that can guide the attention of the wearer such that the eyes of the wearer make a combined motion of far and near, left and right, up and down, circular motion or the like. This may be used for the treatment of myopia.

Such a system greatly enhances the opportunity of its wearer to perform the eye exercises as no dedicated optical elements are required to implement the exercises, such that better adherence to the required exercise regime can be expected. However, a drawback of such a system is that it is unable to determine the suitability of the eye exercises, such that a wearer of such a system unknowingly may perform unsuitable exercises, which may reduce or even cancel the effectiveness of the treatment.

### SUMMARY OF THE INVENTION

The present invention seeks to provide an eye training system including a head-mountable computing device capable of ensuring the suitability of an implemented eye training regime.

The present invention further seeks to provide a computer program product including instructions that facilitate the ensuring of the suitability of the implemented eye training regime when executed on the eye training system.

According to an aspect, there is provided an eye training system including a head-mountable computing device comprising at least one display module arranged to be viewed by the wearer of the head-mountable computing device when wearing the device; and a display processor coupled to the at least one display module for controlling the at least one display module and adapted to display an initial set of eye exercises on the at least one display module; a sensor arrangement for monitoring eye responses of the wearer to the displayed initial set of eye exercises; and a data processor adapted to receive eye response data from the sensor arrangement and to process the eye response data; wherein the display processor is further adapted to display a subsequent set of eye exercises on the at least one display module in response to a processing result of the processed eye response data.

The present inventors have realized that by monitoring the eye responses of a wearer of the head mountable computing device to a set of eye exercises, important information about the suitability of the eye exercises to the treatment of the eye condition of the wearer can be obtained, which information can be used to select the subsequent set of eye exercises to present to the wearer, e.g. by adjusting or replacing the initial set of eye exercises. In this manner, it is ensured that the wearer is presented with suitable eye exercises during the treatment of the relevant eye condition, thereby increasing the effectiveness of the treatment and reducing its overall duration compared to existing treatment methods.

The display processor may be further adapted to display a subsequent set of eye exercises in response to a user instruction based on said processing result. For instance, an eye doctor may evaluate the eye responses to the initial set of eye exercises, select a subsequent set of eye exercises based on the evaluation, and instruct the head-mountable computing device to display the subsequent set of eye exercises next time the wearer engages with the eye exercising regime. To this end, the eye training system may further comprise a data storage device, wherein the data processor is adapted to store the eye response data in the data storage device for periodic evaluation of said data, e.g. by the eye doctor.

Alternatively or additionally, the data processor may be adapted to determine a performance score for said eye response data indicative of the performance of the initial set of eye exercises by the wearer and to select the subsequent set of eye exercises based on said performance score. For instance, the data processor may be adapted to implement a decision process based on eye response metrics to the eye exercises presented to the wearer, such as the percentage of times a set of eye exercises is correctly executed, the parameters of the eye exercises involved, e.g. degree of difficulty, displayed shapes, and so on, and may be adapted to alter the set of eye exercises based on the determined performance of the initial set of eye exercises. This has the advantage that near-instantaneous feedback to the eye exercises is provided, which may even reduce or obviate the need for a clinician such as an eye doctor to be involved with the evaluation of the performance of the eye exercises by the wearer.

The head-mountable computing device may further comprise an audio output device responsive to the display processor, and wherein the display processor is further adapted to output audible instructions on the audio output device when displaying eye exercises on the at least one display module. Such audio output can be used to inform the wearer how to perform the exercises, such that a better compliance with the intended exercise regime may be achieved.

The eye training system may be a distributed system in which the sensor arrangement and the data processor are external to the head-mountable computing device. However, in an alternative embodiment, the head-mountable computing device further comprises at least one of the sensor arrangement and the data processor, and wherein the data processor and the display processor optionally are embodied by a single processor. The head-mountable computing device may comprise both the sensor arrangement and the data processor such that the eye training system is self-contained by the head-mountable computing device.

The sensor arrangement may comprise at least one camera arranged to capture an image of the eye response and to provide the data processor with the captured image, wherein the data processor is adapted to extract the eye response data from the captured image. This is a particularly cost-efficient implementation of such a sensor arrangement, as such image sensors are routinely available at low cost.

In an embodiment, the data processor is further adapted to receive initial eye response data from the sensor arrangement; process the initial eye response data; and select the initial set of eye exercises based on a processing result of the initial eye response data. This has the advantage that a clinician may not be required for defining the initial set of eye exercises, thereby giving the wearer greater autonomy over the implementation of the eye therapy.

In some embodiments, the head-mountable computing device 100 may contain a single display module for displaying eye exercises for one of the eyes of its wearer. Alternatively, the at least one display module includes a first display module arranged to be viewed by one of the eyes of said wearer; and a second display module arranged to be viewed by the other of the eyes of said wearer such that both eyes may be trained.

Each eye exercise may comprise a first image for displaying on the first display module and a second image for displaying on the second display module, the first image being different to the second image, for instance for the purpose of training different eyes with different stimuli in accordance with particular treatment regimes. The display processor may be adapted to simultaneously display the first image and the second image, and wherein one of the first image and the second image is an opaque image. This for instance may be useful for eye exercise regimes in which one of the two eyes may need to be trained, e.g. conditions such as lazy eye (amblyopia).

According to another aspect, there is provided a computer program product comprising a computer-readable medium embodying computer program code for, when executed on at least one of a data processor and a display processor of an eye training system according to any of the above embodiments implement the steps of displaying an initial set of eye exercises on the at least one display module; receiving eye response data from the sensor arrangement and processing the eye response data; and displaying a subsequent set of eye exercises on the at least one display module in response to a processing result of the processed eye response data. Such a computer program product, when executed on an eye training system of the present invention, implements a particularly effective eye training regime as explained in more detail above.

The computer program code may implement the step of displaying the subsequent set of eye exercises in response to a user instruction based on said processing result, such that subsequent eye exercises presented to the wearer of the head-mountable computing device are selected by a clinician, i.e. an eye doctor.

The computer program code may implement the step of producing audible instructions on an audio output device when displaying eye exercises on the at least one display module in order to aid the wearer of the head-mountable computing device in performing the eye exercises in an intended manner.

The computer program code may implement the steps of determining a performance score of said eye response data indicative of the performance of the initial set of eye exercises by the wearer; and selecting the subsequent set of eye exercises based on said performance score such that the eye exercises presented to the wearer may be adjusted by the eye training system without intervention from a clinician such as an eye doctor.

The computer program code may implement the steps of displaying a first image on a first display module of the eye training system; and displaying a second image on a second display module of the eye training system, the first image being different to the second image in order to train separate eye independently, e.g. in accordance with certain treatment regimes. One of the first image and the second image may be an opaque image, which for instance is useful when treating conditions such as lazy eye (amblyopia).

### BRIEF DESCRIPTION OF THE DRAWINGS

Embodiments of the invention are described in more detail and by way of non-limiting examples with reference to the accompanying drawings, wherein:

FIG. 1 schematically depicts an eye training system according to an embodiment;

FIG. 2 schematically depicts an example embodiment of a head-mountable computing device of such an eye training system;

FIG. 3 schematically depicts another example embodiment of a head-mountable computing device of such an eye training system;

FIG. 4 schematically depicts an eye training system according to another embodiment; and

FIG. 5 schematically depicts a flowchart of an eye training method that is performed when the computer program code of a computer program product according to an embodiment is executed on an embodiment of the eye training system of the present invention.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, a head-mountable computing device is a device that can be worn of the head of its user and provides the user with computing functionality. The head-mountable computing device may be configured to perform specific computing tasks as specified in a software application (app) that may be retrieved from the Internet or another computer-readable medium. Non-limiting examples of such head-mountable computing devices include smart headgear, e.g. eyeglasses, goggles, a helmet, a hat, a visor, a headband, or any other device that can be supported on or from the wearer's head, and so on.

In the context of the present application, where reference is made to the detection of eye movement it should be understood that this includes the detection of eye gazing, eye convergence on a virtual focal point on one or more lines perpendicular to the eye pupils, signs of eye fatigue, e.g. eye response speed, the detection of lack of eye movement for a period of time, such as the ability to maintain eye focus or the duration of gazing, and so on. In general, the term eye movement is intended to cover all the clinically relevant information that may be obtained by monitoring one eye or both eyes using suitable tracking sensors such as eye tracking sensors and image sensors, e.g. cameras.

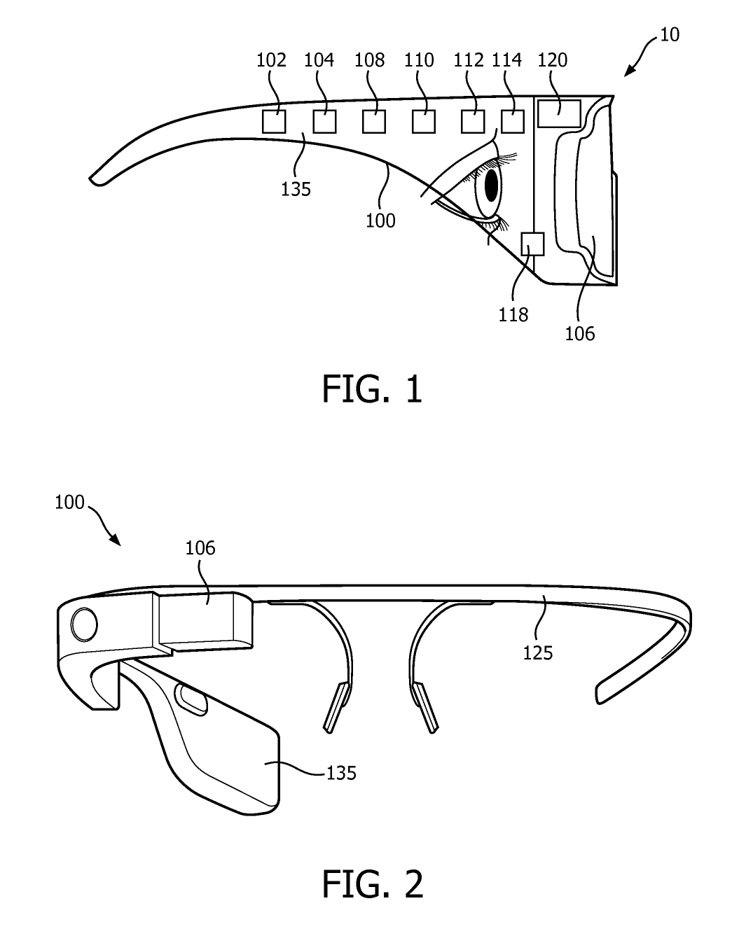

FIG. 1 schematically depicts an eye training system 10 implemented on a head-mountable computing device 100 according to an embodiment. By way of non-limiting example, the head-mountable computing device 100 is depicted as smart glasses, but it should be understood that the head-mountable computing device 100 may take any suitable shape as previously explained. The head-mountable computing device 100 typically comprises at least one display module 106, which may be a see-through or transparent display module 106, under control of a discrete display processor 108. Alternatively, the display processor 108 and the data processor 110 may be implemented by a single processor, e.g. a general purpose processor or an application specific integrated circuit (ASIC).

The eye training system 10 further comprises a sensor arrangement comprising at least one sensor 120 for tracking or otherwise monitoring eye movement of the wearer of the head-mountable computing device 100, typically eye movement induced by displaying eye training exercises on the at least one display module 106, as will be explained in more detail below. Any suitable type of eye monitoring sensor 120 may be used for this purpose, such as a dedicated eye tracking sensor or an inward facing image sensor, e.g. camera or the like, that captures images of the eye(s) of the wearer of the head-mountable computing device 100 and communicates these images to the data processor 110 for determination of the eye movement captured in the images. As such sensors are known per se, they will not be explained in further detail for the sake of brevity. It should be understood that any suitable type of eye movement sensor may be used for this purpose.

In some embodiments, the head-mountable computing device 100 may be adapted to wirelessly communicate with remote components of the eye training system 10, as will be explained in more detail below. To this end, the head-mountable computing device 100 may include a wireless communication interface 102 for wirelessly communicating with such a remote target.

Any suitable wireless communication protocol may be used for any of the wireless communication between the head-mountable computing device 100 and the remote components, e.g., an infrared link, Zigbee, Bluetooth, a wireless local area network protocol such as in accordance with the IEEE 802.11 standards, a 2G, 3G or 4G telecommunication protocol, and so on. The remote components may for instance be adapted to display eye training results obtained by the eye training system 10 on a remote display such that an eye doctor may remotely evaluate the eye training data and adjust the eye training exercises accordingly, e.g. by defining an adjusted set of eye training exercises for wireless communication to the head-mountable computing device 100 through the wireless communication interface 102.

The head-mountable computing device 100 may optionally comprise a further wireless communication interface 104 for wirelessly communicating with a further remote system, e.g. a wireless LAN, through which the head-mountable computing device 100 may access a remote data source such as the Internet, for instance to store captured eye response data in an appropriate database, such as a patient database.

Alternatively, the head-mountable computing device 100 may include one wireless communication interface that is able to communicate with various remote targets. The data processor 110 may further be adapted to control wireless communication interface 102 and, if present, wireless communication interface 104.

In some embodiments, the head-mountable computing device 100 may be arranged to detect a user instruction and to trigger an operation in response to the detected user instruction, e.g. using at least one further sensor 118 including a motion sensor like a gyroscope or similar in case the user instruction is a head motion, or by including an outward-facing image sensor or camera to capture an image of a gesture-based instruction made by the wearer. Other suitable sensors for such gesture or motion capturing will be apparent to the skilled person.

The data processor 110 may be arranged to recognize a gesture or motion made by its wearer from the captured sensor data and to interpret the recognized gesture or motion as an instruction, for instance to upload the captured eye response data into a database such as a patient database or to initiate an eye training exercise. Non-limiting examples of such a motion for instance include a turn or nod of the wearer's head. Non-limiting examples of such a gesture for instance include a hand or finger gesture in the field of view through the head-mountable computing device 100, which may be detected in an image captured with the outward facing image sensor. Alternatively, such instructions may be captured by the inward facing eye movement sensor(s) 120, for instance when the wearer of the head-mountable computing device 100 is not engaged in eye training exercises, in which case the data processor 110 may be adapted to interpret particular eye movements, e.g. blinking or the like, as a particular instruction.

Alternatively or additionally, the at least one further sensor 118 may include a sound sensor, e.g. a microphone, may be present to detect a spoken instruction, wherein the processor 110 may be communicatively coupled to the further sensor in order to process the sensor data and detect the spoken instruction.

The at least one further sensor 118 may additionally or alternatively include an input sensor, e.g. a button or the like for facilitating the wearer of the head-mountable computing device 100 to select the user instruction from a list of options. Such list of options for instance may be displayed on a display module 106 of the head-mountable computing device 100. Such an input sensor may form part of a user interface for receiving input from the user. Such a user interface may include, for example, a touchpad, a keypad, buttons, a microphone, and/or other input devices. The data processor 110 may control at least some of the functioning of head-mountable computing device 100 based on input received through the user interface. In some embodiments, any of the at least one further sensors 118 may define or form part of the user interface.

In some embodiments, the head-mountable computing device 100 may further comprise an audio output device 114 such as a loudspeaker or the like for providing the wearer of the head-mountable computing device 100 with audio instructions, e.g. spoken instructions explaining the eye training exercises to be displayed on the at least one display module 106, as will be explained in more detail below. Any suitable audio output device may be used for this purpose.

The head-mountable computing device 100 may further comprise a data storage device 112, e.g. for storing the eye exercises and/or for storing the eye response data to these exercises as will be explained in more detail below. Any suitable type of data storage may be used, e.g. non-volatile or flash memory, PROM, EEPROM and so on.

The various components of the head-mountable computing device 100 may be integrated in the device in any suitable manner, such as integrated in a part 135 of a mounting frame of the head-mountable computing device 100 by way of non-limiting example.

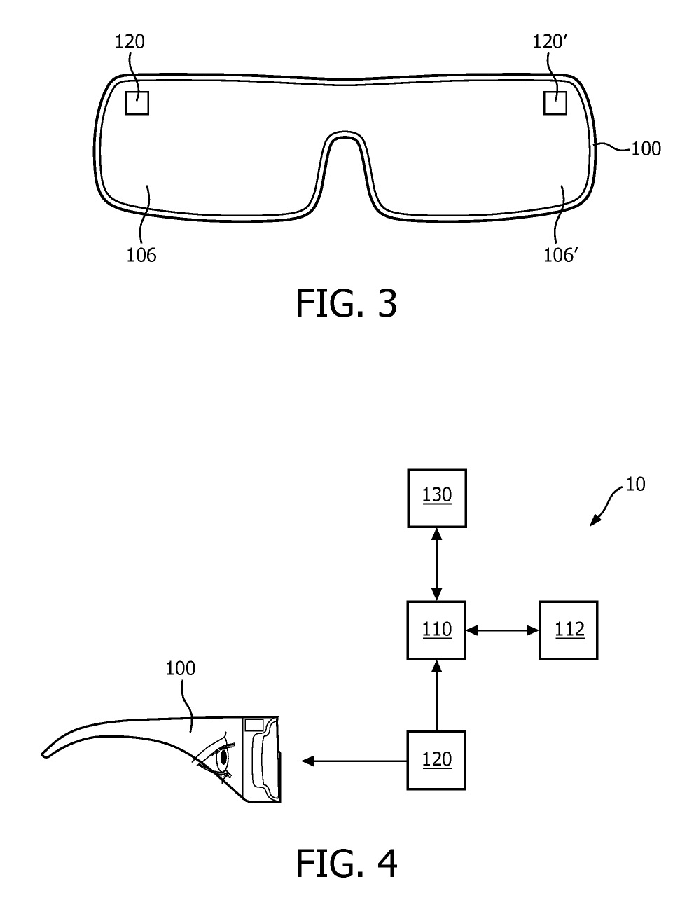

FIG. 2 schematically depicts an example embodiment of the head-mountable computing device 100 in which the device comprises a single display module 106 only, which single display module 106 may be arranged to be observable by a single eye of the wearer of the head-mountable computing device 100, here the right eye by way of non-limiting example only, whereas FIG. 3 schematically depicts an example embodiment of the head-mountable computing device 100 in which the device comprises a pair of display modules 106, 106′ with each display module arranged to be observed by one of the eyes of the wearer of the head-mountable computing device 100, in which case the head-mountable computing device 100 may include multiple sensors for monitoring the eye movement of the wearer when the wearer is performing the eye training exercises. By way of non-limiting example, the head-mountable computing device 100 as shown in FIG. 3 comprises a first eye monitoring sensor 120 for monitoring eye movement triggered by the exercises displayed on the first display module 106, here right eye movement, and a second eye monitoring sensor 120′ for monitoring eye movement triggered by the exercises displayed on the second display module 106′, here left eye movement. As previously explained, the eye monitoring sensors 120, 120′ may be any suitable type of sensor for tracking eye movement, such as eye tracking sensors or inward facing image sensors for capturing images of the eye movement, which images may be processed by the data processor 110 in order to determine the aforementioned eye movement.

The at least one display module 106 is typically arranged such that a wearer of the head-mountable computing device 100 can observe an image displayed on the at least one the display module 106. Preferably, the at least one display module 106 is a see-through or transparent display module such that the wearer can observe at least a part of a field of view through the display module 106, such that the wearer can wear the head-mountable computing device 100 whilst performing routine daily tasks.

The at least one display module 106 may be provided in any suitable form, such as a transparent lens portion. Alternatively, the head-mountable computing device 100 may comprise a pair of such a lens portions, i.e. one for each eye as explained above. The one or more transparent lens portions may be dimensioned such that substantially the entire field of view of the wearer is obtained through the one or more transparent lens portions, as shown in FIG. 3. For instance, the at least one display module 106 may be shaped as a lens to be mounted in the frame 125 of the head-mountable computing device 100.

It will be understood that the frame 125 may have any suitable shape and may be made of any suitable material, e.g. a metal, metal alloy, plastics material or combination thereof. Several components of the head-mountable computing device 100 may be mounted in the frame 125, such as in a component housing 135 forming part of the frame 125. The component housing 135 may have any suitable shape, preferably an ergonomic shape that allows the head-mountable computing device 100 to be worn by its wearer in a comfortable manner.

It is reiterated that FIGS. 2 and 3 schematically depict non-limiting examples of such head-mountable computing devices 100 and that any suitable head-mountable computing device having any suitable display module configuration may be used in the eye training system 10 of the present invention.

In the above embodiments of the eye training system 10, the eye training system 10 has been embodied in its entirety by the head-mountable computing device 100. However, it should be understood that it is equally feasible that at least some of the elements of the eye training system 10 are separate to the head-mountable computing device 100, thereby yielding a distributed eye training system 10. FIG. 4 schematically depicts an example embodiment of such a distributed eye training system 10, in which the eye monitoring sensor arrangement 120 is external to the head-mountable computing device 100.

For instance, the external eye monitoring sensor arrangement 120 may comprise one or more image sensors, e.g. HD image sensors, arranged to capture images of the eyes of the wearer of the head-mountable computing device 100 when performing the eye exercises displayed on the one or more display modules 106. To this end, the external eye monitoring sensor arrangement 120 may be arranged in a fixed orientation relative to the wearer, for instance mounted on an object such as a wall, a piece of furniture, an electronic device, and so on, wherein the wearer of the head-mountable computing device 100 is instructed to face this object when performing the eye training exercises such that the external eye monitoring sensor arrangement 120 can capture the images of the eye movement induced by the wearer performing the exercises.

The external eye monitoring sensor arrangement 120 may be communicatively coupled to the data processor 110 in any suitable manner, e.g. over a wireless link as previously explained. The data processor 110 may be embodied by the head-mountable computing device 100 or alternatively may be external to this device, for instance as part of an external computing device adapted to process the eye movement captured by the external eye movement sensor arrangement 120, which has the advantage that the head-mountable computing device 100 requires less computing power, which may be beneficial to the battery life of the head-mountable computing device 100.

In an embodiment, the data storage 112 may be external to the head-mountable computing device 100, e.g. part of the external computing device, such that the data processor 110 may store processed eye movement data for evaluation by a clinician such as an eye doctor in the external data storage 112. This has the advantage that the clinician is not dependent on a communications link with the head-mountable computing device 100 being available when wanting to evaluate the eye movement data stored in data storage 112.

The external components may further include a further user interface 130 for allowing the clinician to adjust a set of eye training exercises to be displayed on the at least one display module 106 of the head-mountable computing device 100 for communication of the adjusted set of exercises to the head-mountable communication device 100. Such an indication may be established in any suitable manner, e.g. wireless communication under the control of the external data processor 110.

It should be understood that FIG. 4 simply is an example embodiment of a distributed eye training system 10 and that different degrees of distribution for such an eye training system, i.e. different numbers of components being external to the head-mountable computing device 100, will be immediately apparent to the skilled person.

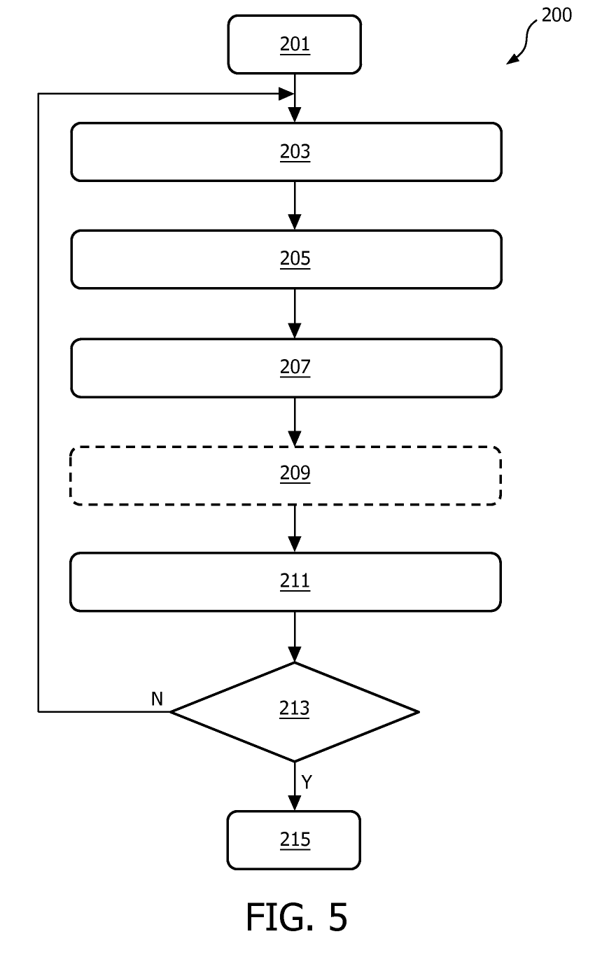

The operation of the eye training system 10 will now be explained in more detail with the aid of FIG. 5, which depicts a flowchart of an eye training method that may be implemented by the eye training system 10, either when fully embodied on the head-mountable computing device 100 or when distributed, i.e comprising one or more components external to the head-mountable computing device 100. In an embodiment, the steps of the eye training method are embodied in computer program code stored on a computer-readable medium of a computer program product for execution by the eye training system 10.

The method 200 starts in step 201, which typically includes initializing the eye training system 10, which for instance may include powering up the head-mountable computing device 100 and/or selecting an eye training mode of the eye training system 10, which for instance may be achieved by providing the head-mountable computing device 100 with an appropriate instruction by its wearer as previously explained.

Next, an initial set of eye exercises is selected in step 203. This initial set of eye exercises may be selected by a clinician such as an eye doctor following consultation of the wearer of the head-mountable computing device 100. The clinician for instance may select an initial set of eye exercises from a library of eye exercises stored in the data storage 112 or another data storage such as a remote data storage wirelessly accessible by the head-mountable computing device 100 or may indicate to the wearer which set of eye exercises should be selected from the data storage 112 or from the remote data storage such that in step 203 the wearer selects the appropriate set of eye exercises to be displayed on the at least one display module 106 of the head-mountable computing device 100. It will be appreciated that the clinician or the wearer may select the initial set of eye exercises in any suitable manner.

In an alternative embodiment, the eye training system 10 may be configured to autonomously select the initial set of eye exercises based on an evaluation of eye movements of the wearer, such as eye movements of the wearer performing routine tasks such as reading, driving, watching a display screen or a television, and so on. To this end, the eye movement sensor arrangement 120 may provide the data processor 110 with eye movement data associated with the performance of these routine tasks, wherein the data processor 110 may be adapted to evaluate the eye movement data, e.g. images of the eye movement captured by one or more image sensors or eye tracking data captured by one or more eye tracking sensors, wherein the data processor 110 is adapted to recognize deviations from expected eye movement, correlate these deviations with a particular eye condition and select an initial set of training exercises appropriate for the diagnosed eye condition. For instance, the data processing 110 may be adapted to recognize differences in responsiveness, focus, tracking and so on between the left and right eye of the wearer of the head-mountable computing device 100, which differences may be correlated to a particular eye condition. To this end, the eye training system 10 for instance may comprise a look up table stored in any suitable data storage such as the data storage 112 or a remote data storage, which look up table comprises a list of differences that may be detected by the data processor 110 and a list of eye conditions and/or initial eye exercises associated with the detected differences.

The eye exercises to be displayed on the at least one display module 106 of the head-mountable computing device 100 may take any suitable form, for instance as an object or shape captured in a series of images that when displayed on the at least one display module 106 causes the object are shaped to move on the display module 106, wherein the wearer has to track the object or shape. The object or shape may change form or size or the speed at which the object or shape moves over the display module 106 may be altered during or between sets of exercises if required, e.g. to adjust a difficulty level of the set of exercises; the object or shape may be permanently displayed or may be intermittently displayed if required, and so on. In case of a head-mountable computing device comprising a pair of display modules, different images may be displayed on the different display modules such that the left and right eye of the wearer are trained independently, as for instance required by a particular therapy for a particular eye condition such as strabismus. For instance, different images may be displayed simultaneously or may be displayed in turn on the different display modules for this purpose. In an embodiment, one of the images may be a substantially homogeneous opaque image to block light reaching the eye aligned with the display module on which the opaque images displayed, such that a single eye of the wearer may be trained by a sequence of images displayed on the other of the two display modules, as for instance is common practice in therapies for treating lazy eye (amblyopia). It will be immediately apparent to the skilled person such as an eye doctor, e.g. an orthoptist or optometrist that many other suitable types of eye exercises are readily available for display on the one or more of display modules 106. It should be understood that the present invention is not limited to a particular embodiment of such eye exercises to be displayed, and that any suitable eye exercise regime may be contemplated.

After selection of the appropriate set of eye exercises as explained above, the method 200 proceeds to step 205 in which the exercises are displayed on the one or more display modules 106, e.g. on the control of the display processor 108. As explained above, this may include displaying images embodying eye exercises on a single display module 106 as well as displaying images embodying eye exercises on a pair of display modules 106. In an embodiment, the wearer of the head-mountable computing device 100 may further be provided with instructions on how to perform the eye exercises displayed on the one or more display modules 106. Such instructions may be provided on the one or more display modules 106, for instance in the form of written text or intuitive pictograms helping the wearer to understand what is expected and/or what needs to be done, e.g. how the exercises are to be performed, and so on. Alternatively or additionally, instructions may be provided in audible form, e.g. on the audio output device 114.

In step 207, the sensor arrangement 120 captures the eye responses of the wearer of the head-mountable computing device 100 on which the eye exercises are displayed, for instance by using one or more eye movement sensors 120 integrated in the head-mountable computing device 100 or one or more eye movement sensors 120 external to the device as previously explained in more detail. In an embodiment, the eye responses are captured as a stream of sensor signals, e.g. images, and forwarded to the data processor 110 for processing, wherein the data processor 110 extracts the eye movement from the stream of sensor signals, for instance by using well-known object recognition techniques. The data processor 100 may optionally store the extracted eye responses in data storage 112 for later evaluation in optional step 209, e.g. by a clinician such as an eye doctor as previously explained. In addition to the captured eye movement data, relevant details about the performed set of eye exercises, such as degree of difficulty, point in time at which the exercises were performed, and a performance score indicating how well the wearer performed the exercises as will be explained in further detail below, may also be stored, as such information may aid the clinician to evaluate the eye responses of the wearer of the head-mountable computing device 100 to the eye exercises displayed on the one or more display modules 106.

The eye response data captured in step 207 and optionally stored in step 209 is subsequently evaluated in step 211. This evaluation may be performed in several ways, some of which will be explained in more detail below by way of non-limiting example; the skilled person will immediately realize that variations to these examples are equally feasible.

In an example embodiment, the stored eye response data may be periodically transmitted to a remote target, e.g. a remote computer, using any of the aforementioned suitable transmission techniques, for evaluation by the clinician. The clinician for instance may evaluate how well the wearer of the head-mountable computing device 100 has executed the exercises displayed on one or more display modules 106 and may adjust the set of exercises based on the evaluation, for instance to make the exercises more difficult or easier for instance when the actual compliance of the wearer with the exercises differs from the expected compliance, or when the eye responses of the wearer indicate that the eye condition of the wearer has changed such that an adjusted set of eye exercises should be subsequently displayed on the head-mountable computing device, and so on. The clinician may trigger the communication of the adjustable set of eye exercises from the remote computer to the head-mountable display device 100 or in case the adjusted set of eye exercises are already present on the head-mountable display device 100, e.g. stored in a data storage 112 thereof, may trigger the sending of an indication of the adjustable set of exercises to be selected to the head-mountable display device 100, either for automatic selection or for selection by the wearer of the device.

In another example embodiment, the eye training system 10 may be adapted to autonomously determine if and how the initial set of eye exercises need to be adjusted by performing an evaluation of the captured eye response data on the eye training system 10, e.g. by means of the data processor 110. In this embodiment, the eye training system 10 may be adapted to dynamically change the parameters of a set of eye exercises by a decision making process that determines a performance score indicating how well the wearer has performed the initial set of exercises, i.e. how well the wearer has complied with these exercises, and adjusts the initial set of exercises based on the determined performance score where necessary.

For instance, the eye training system 10 may be adapted to calculate the percentage of times the wearer correctly executed a particular exercise in a sequence of exercises including a given set of parameters such as stimulus size, shape, time of exposure, interval between stimuli and so on, e.g. by comparing expected eye movement with captured eye movement, and to determine based on the calculated performance score if and how the initial set of eye exercises should be adjusted. For instance, the eye training system 10 may adjust, e.g. increase the difficulty of, the set of eye exercises upon the performance score exceeding a defined threshold.

In an embodiment, such an evaluation may further comprise comparing the determined performance score with a previously determined performance score to identify trends in the values of this score, for instance to determine if the eye condition of the wearer is improving or deteriorating such that an indication of the success of the therapy can be obtained and the therapy adjusted accordingly in this manner.

In an embodiment, the eye training system 10 is adapted to distinguish between isolated mistakes and systematic mistakes made by the wearer of the head-mountable computing device 100. This for instance may be done by evaluating for a particular type of exercise that has been repeated several times how often the wearer failed to correctly perform the exercise. In case of systematic mistakes being diagnosed in this manner, the system may reduce the complexity or otherwise alter the set of exercises in order to make the exercises more suitable for the wearer.

In an embodiment, this decision process is performed in between sets of exercises with which the wearer of the head-mountable computing device 100 is presented. Alternatively, this decision process may be applied during the execution of a set of exercises such that a subset of the exercises, i.e. the exercises yet to be displayed, may be amended in accordance with the performance score determined based on the eye movement data collected for the already displayed images (exercises) of the set of exercises.

In embodiments where the eye training system 10 is arranged to autonomously evaluate the eye responses captured in step 207 as previously explained, the eye training system 10 may be further adapted to periodically send information about the training program to a remote destination for evaluation by the clinician, e.g. a remote computer or the like as previously explained. Such information for instance may comprise eye response information stored in data storage 112 as previously explained as well as information regarding the performance scores calculated by the system and adjustments made to the training regime in accordance with the calculator performance scores. This for instance may facilitate the clinician to make further adjustments to the training regime if considered necessary or may simply serve the purpose of keeping the clinician informed about the progress of the treatment of the eye condition of the wearer of the head-mountable computing device 100.

In step 213, it may be decided if the eye therapy should be continued, which may cause the method 200 to refer back to step 203 in which the appropriate set of eye exercises to be displayed on the at least one display module 106 is selected as previously explained if the therapy is to be continued. If the therapy is to be discontinued, either temporarily or permanently, the method 200 may proceed to step 215 in which the method 200 terminates.

Aspects of the present invention may be embodied as an eye training system entirely embodied by a head-mountable computing device or distributed over separate entities including a head-mountable computing device. Aspects of the present invention may take the form of a computer program product embodied in one or more computer-readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

Such a system, apparatus or device may be accessible over any suitable network connection; for instance, the system, apparatus or device may be accessible over a network for retrieval of the computer readable program code over the network. Such a network may for instance be the Internet, a mobile communications network or the like. More specific examples (a non-exhaustive list) of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present application, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out the methods of the present invention by execution on the processor 110 may be written in any combination of one or more programming languages, including an object oriented programming language such as Java, Smalltalk, C++ or the like and conventional procedural programming languages, such as the “C” programming language or similar programming languages. The program code may execute entirely on the processor 110 as a stand-alone software package, e.g. an app, or may be executed partly on the processor 110 and partly on a remote server. In the latter scenario, the remote server may be connected to the head-mountable computing device 100 through any type of network, including a local area network (LAN) or a wide area network (WAN), or the connection may be made to an external computer, e.g. through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions to be executed in whole or in part on the display processor 108 and/or the data processor 110 of the eye training system 10 including the head-mountable computing device 100, such that the instructions create means for implementing the functions/acts specified in the flowchart and/or block diagram block or blocks. These computer program instructions may also be stored in a computer-readable medium that can direct the eye system 10 including the head-mountable computing device 100 to function in a particular manner.

The computer program instructions may be loaded onto the display processor 108 and/or the data processor 110 to cause a series of operational steps to be performed on the display processor 108 and/or the data processor 110, to produce a computer-implemented process such that the instructions which execute on the display processor 108 and/or the data processor 110 provide processes for implementing the functions/acts specified in the flowchart and/or block diagram block or blocks. The computer program product may form part of an eye training system 10 including the head-mountable computing device 100, e.g. may be installed on the eye training system 10.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An eye training system including:
a head-mountable computing device comprising:
at least one display module (arranged to be viewed by the wearer of the head-mountable computing device when wearing the device; and
a display processor coupled to the at least one display module for controlling the at least one display module and adapted to display an initial set of eye exercises on the at least one display module;
a sensor arrangement for monitoring eye responses of the wearer to the displayed initial set of eye exercises; and
a data processor adapted to receive eye response data from the sensor arrangement and to process the eye response data;
wherein the display processor is further adapted to display a subsequent set of eye exercises on the at least one display module in response to a processing result of the processed eye response data.

2. The eye training system of claim 1, wherein the display processor is further adapted to display a subsequent set of eye exercises in response to a user instruction based on said processing result.

3. The eye training system of claim 1, wherein the data processor is adapted to determine a performance score for said eye response data indicative of the performance of the initial set of eye exercises by the wearer and to select the subsequent set of eye exercises based on said performance score.

4. The eye training system of claim 1, wherein the head-mountable computing device further comprises an audio output device responsive to the display processor, and wherein the display processor is further adapted to output audible instructions on the audio output device when displaying eye exercises on the at least one display module.

5. The eye training system of claim 1, wherein the head-mountable computing device further comprises at least one of the sensor arrangement and the data processor, and wherein the data processor and the display processor optionally are embodied by a single processor.

6. The eye training system of claim 1, wherein the sensor arrangement comprises at least one camera arranged to capture an image of the eye response and to provide the data processor with the captured image, wherein the data processor is adapted to extract the eye response data from the captured image.

7. The head-mountable computing device of claim 6, wherein the data processor is further adapted to:
receive initial eye response data from the sensor arrangement;
process the initial eye response data; and
select the initial set of eye exercises based on a processing result of the initial eye response data.

8. The eye training system of claim 1, further comprising a data storage device, and wherein the data processor is adapted to store the eye response data in the data storage device for periodic evaluation of said data.

9. The eye training system of claim 8, wherein the at least one display module includes:
a first display module arranged to be viewed by one of the eyes of said wearer; and
a second display module arranged to be viewed by the other of the eyes of said wearer.

10. The eye training system of claim 8, wherein each eye exercise comprises a first image for displaying on the first display module and a second image for displaying on the second display module, the first image being different to the second image, and wherein the display processor (108) optionally is adapted to simultaneously display the first image and the second image, and wherein one of the first image and the second image is an opaque image.

11. A computer program product comprising a computer-readable medium embodying computer program code for, when executed on at least one of a data processor and a display processor of an eye training system according to claim 1 implement the steps of:
displaying an initial set of eye exercises on the at least one display module,
receiving eye response data from the sensor arrangement and processing the eye response data; and
displaying a subsequent set of eye exercises on the at least one display module in response to a processing result of the processed eye response data.

12. The computer program product of claim 11, wherein the computer program code implements the step of displaying the subsequent set of eye exercises in response to a user instruction based on said processing result and/or implements the step of producing audible instructions on an audio output device when displaying eye exercises on the at least one display module.

13. The computer program product of claim 11, wherein the computer program code implements the steps of:
determining a performance score for said eye response data indicative of the performance of the initial set of eye exercises by the wearer; and
selecting the subsequent set of eye exercises based on said performance score.

14. The computer program product of claim 13, wherein the performance score is based on a percentage of correctly performed eye exercises.

15. The computer program product of claim 12, wherein the computer program code further implements the steps of:
displaying a first image on a first display module of the eye training system; and
displaying a second image on a second display module of the eye training system, the first image being different to the second image.
